(19) United States
(12) Patent Application Publication
(10) Pub. No.: US 2015/0098767 A1
(43) Pub. Date: Apr. 9, 2015

(54) AIR SEEDER MANIFOLD APPARATUS

(71) Applicant: STRAW TRACK MANUFACTURING INC., Saskatchewan (CA)

(72) Inventors: Norbert Beaujot, Saskatchewan (CA); Greg Vennard, Emerald Park Saskatchewan (CA)

(21) Appl. No.: 14/355,824

(22) PCT Filed: Oct. 24, 2012
(86) PCT No.: PCT/CA2012/000979

§ 371 Date: May 1, 2014

(30) Foreign Application Priority Data
Nov. 1, 2011 (CA) 2756635

(51) Int. Cl. A01C 7/08; A01C 7/20

(52) U.S. Cl. CPC A01C 7/084; A01C 7/20
USPC 406/181; 406/191

(57) ABSTRACT

A manifold apparatus for an air seeder has output ports spaced around a lower portion of the sidewall A vertically oriented input conduit extends upward through an input port defined in the bottom of the manifold into an upper portion of the manifold interior. A plurality of substantially vertical channels each extend downward from an inner top wall surface to one of the outlet ports and has an entrance opening at a top end thereof. The upper portion of the manifold interior is configured such that an air stream carrying entrained agricultural products passing out an open top end of the input conduit contacts the top wall and is directed outward into the entrance openings, and such that a substantially equal portion of the air stream and agricultural products flows into each entrance opening. Blunt edged pulsating rings can distribute agricultural products evenly across the input conduit.

This invention is in the field of agricultural air seeders and in particular a manifold apparatus for dividing and distributing the air stream and agricultural products entrained therein.

### BACKGROUND

Air seeders are well known for seeding agricultural crops. Air seeders typically comprise a frame with furrow openers mounted thereon that are configured to create furrows in a field surface. Air seeders include one or more tanks containing agricultural products such as seeds, chemicals, and fertilizers. Metering devices dispense agricultural products from each tank into a distribution network connected between the tanks and the furrow openers, and a fan creates an air stream flowing through the distribution network to carry the agricultural products from the tanks to the furrow openers. The distribution network commonly includes one or more larger primary conduits from the tanks to the frame, which are connected to the input port of a manifold which receives the air stream and divide and direct the air stream, and the agricultural products entrained in the air stream, through output ports into a number of smaller secondary conduits. The secondary conduits carry the air stream and products downstream to another manifold for further division, or to the furrow openers.

The air flow through the distribution network must be sufficient to maintain the agricultural products in the air stream. When the air stream is too slow, the product drops out of the air flow and plugs the conduit. As farmers farm larger tracts of land, air seeders have become wider, and the conduit network longer, and plugging becomes more problematic. Longer conduits require a higher velocity air stream in order to ensure the products are maintained in the air stream.

Higher product and air velocities can damage the seeds as a result of collision with other seeds or hard surfaces. Seeds traveling at high speed out of the output end of a conduit at the furrow opener often hit the bottom of the furrow and then bounce up, landing in the looser soil above the bottom of the furrow, or even bouncing completely out of the furrow. Equipment and power requirements are also greater where more and faster air is required. Reducing the resistance to air flow through out the distribution network is therefore desirable.

In order to achieve substantially equal division of the agricultural products entrained in the air stream, it is necessary to have the products randomly distributed across the cross-section of the primary conduit as it enters the manifold input port. The air stream entering the manifold moves substantially equally out of the manifold through each output port, and an imbalance in the amount of product in one part of the air stream compared to another will result in a similar imbalance in the quantity of agricultural products carried out through one output port compared to another.

In a typical configuration, the manifold is a short cylindrical shape and is mounted on top of a vertical tower section of the primary conduit. The input port is at the center of the bottom plate of the manifold, and the output ports are equally spaced around the cylindrical wall of the manifold between the top and bottom plates. The number of output ports will vary with the particular application.

The vertical tower section helps to move the suspended product into a more even or centered distribution across the cross section of the tower portion of the primary conduit. The bottom end of the tower section is connected through a curved elbow to a horizontal section of the primary conduit. In the horizontal section the agricultural products tend to move toward the bottom side of the conduit in response to gravity, and the vertical tower section is designed to take out the effects of gravity. As the air flow moves around the curve elbow at the bottom of the manifold system the product tends toward the outside of the curve giving an offset distribution of product, and various means are then used to shift the product to a random or centered distribution.

For example, U.S. Pat. No. 4,575,284 to Kelm provides projections or dimples extending inward from the wall of the vertical tower section to help the granular material reach the manifold input port in a centered, accurate stream. Canadian Patent Number 2,111,611 to Bourgault discloses a seed centering system comprising one or more tapered centering rings which direct the agricultural products away from the walls toward the center of the horizontal and vertical tower sections of the primary conduit. A divider in the elbow also reduces the movement of product toward the outside of the elbow.

U.S. Pat. No. 6,290,433 to Poncelet discloses a manifold where the input port gradually tapers inwardly in the direction of the flow to accelerate and centre the flow as it enters the manifold. Poncelet also discloses a manifold top plate or cap with a downward extending point centered on the central axis of the input port. A series of smoothly curved grooves and ridges extending from the point upward and curving 90 degrees to connect the grooves with the output ports. Corresponding grooves and ridges are provided in the bottom plate and the ridges in the top and bottom plates cooperate to essentially form substantially separate channels from an open area just above the input port near the point to each output port.

Similarly, Canadian Patent Application Number 2,073,237 of Memory discloses a divider header or manifold for air seeders where the vertically oriented input port tapers inwardly in the upward direction of air stream flow to centre the flow as it enters the manifold. The upward flowing air stream contacts a downward extending point centered on the central axis of the input port, and then flows into individual output channels which extend upward at an angle and then curve downward to out ends that are adapted to be connected to secondary conduits.

The Poncelet and Memory devices are directed to providing a smooth flow of product from the input to the output ports in order to reduce flow resistance, as well as providing equal distribution of the agricultural products in the air stream.

### SUMMARY OF THE INVENTION

It is an object of the present invention to provide an air stream distributing manifold apparatus for an air seeder that overcomes problems in the prior art.

In a first embodiment the present invention provides a manifold apparatus for an air seeder. The apparatus comprises a top wall, a bottom wall, and a side wall enclosing a manifold interior. A plurality of output ports is defined in a lower portion of the side wall, and spaced around the sidewall, each output port adapted for connection to a secondary conduit. An input port is defined in the bottom wall, and a substantially vertically oriented input conduit extends upward through the input port into an upper portion of the manifold interior. A plurality of substantially vertical channels each extend downward from an inner top wall surface to one of the outlet ports and has an entrance opening at a top end thereof. The upper portion of the manifold interior is configured such that an air stream carry entrained agricultural products passing out an open top end of the input conduit contacts the top wall and is directed outward into the entrance openings, and such that a substantially equal portion of the air stream and agricultural products flows into each entrance opening.

In a second embodiment the present invention provides a substantially vertical input conduit for an air seeder manifold. A bottom end of the input conduit is connected through an elbow to a horizontal conduit, and a top end of the input conduit is connected to an input port of the manifold. The input conduit comprises at least one pulsating ring located inside the input conduit between the elbow and the top end thereof, and a bottom edge of the at least one pulsating ring extends inward substantially perpendicularly from an inner surface of the input conduit.

In response to impact with dimples in the vertical input conduit, or in one aspect of the invention impact with blunt bottom edges of pulsating rings disposed in the input conduit, the particles of agricultural products entrained in the air stream spin and bounce against each other such that the particles have kinetic energy not only from their forward motion in the direction of the air stream along the input conduit, but also random kinetic energy from spinning and moving laterally randomly across the input conduit. In the present invention the particles are not centered in the air stream when same enters the input port of the manifold, but rather are randomly and equally distributed across the cross-section of the input conduit so that any selected portion of the air stream contains about the same quantity of particles as any other selected portion of the same size. Thus when the center of the air stream contacts the pointed end of the divider cone, the air stream flows equally up all around the slope of the cone and equally into each channel, and an equal amount of product is carried into each channel.

Advantageously the cross-sectional area of at least a middle portion of each channel is greater than the cross-sectional area of the secondary conduits, and is also greater than the cross-sectional area of the channel entrance opening. As the air stream passes through the entrance openings into the channels, the speed of the air stream drops somewhat and the particles are also accelerated by gravity which reorients and reduces the random kinetic energy of the particles, and the incidence of plugging is reduced.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a cut-away side view of an embodiment of a manifold apparatus of the present invention for an air seeder;

FIG. 2 is a cut-away side view of the embodiment of FIG. 1 with the cap removed;

FIG. 3 is a perspective exterior view of the embodiment of FIG. 1 with the cap removed;

FIG. 4 is a perspective exterior view of the embodiment of FIG. 1 with the cap installed;

FIG. 5 is a perspective view of an annular channel insert member that is inserted in the manifold interior between the sidewall and the input conduit to provide the channels;

FIG. 6 is a schematic illustration of the relative areas of a channel and a secondary conduit;

FIG. 7 is a perspective view of another embodiment of a manifold apparatus of the present invention for an air seeder;

FIG. 8 is a perspective view of the cap of the embodiment of FIG. 7;

FIG. 9 is a schematic side sectional view of a further alternate embodiment of a manifold apparatus of the present invention for an air seeder.

### DETAILED DESCRIPTION OF THE ILLUSTRATED EMBODIMENTS

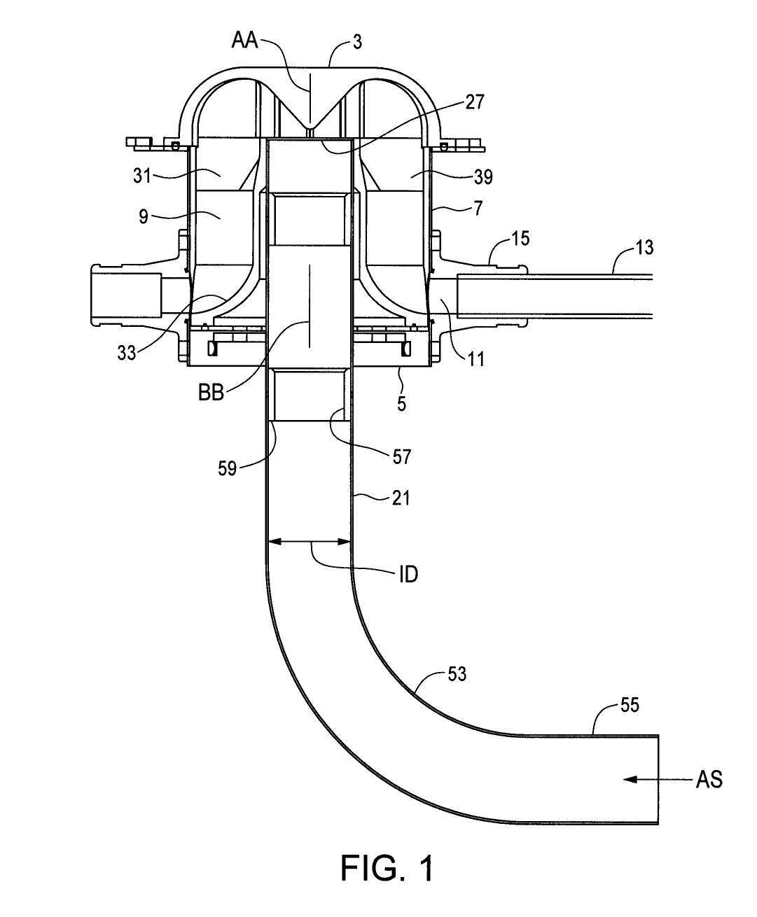

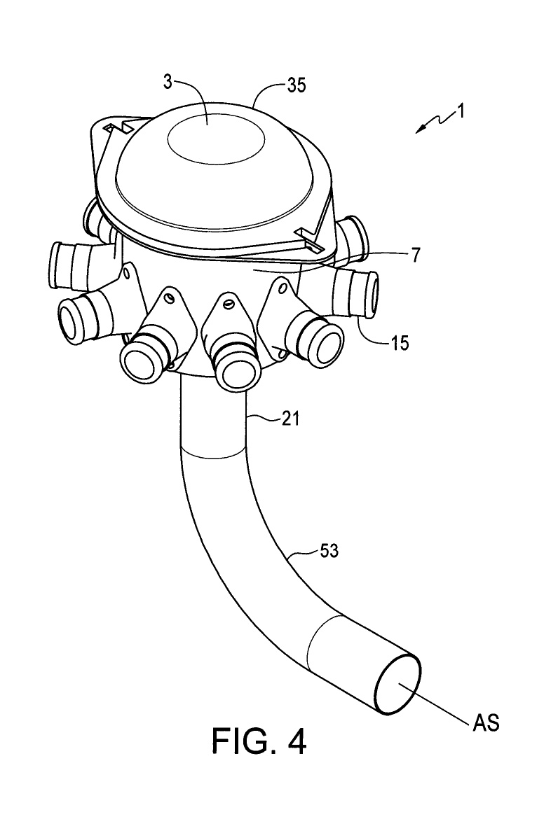

FIGS. 1-4 illustrate an embodiment of a manifold apparatus 1 of the present invention for use on an air seeder. The apparatus 1 comprises a top wall 3, a bottom wall 5, and a sidewall 7 enclosing a manifold interior 9.

A plurality of output ports 11 are defined in a lower portion of the sidewall 7, and are equally spaced around the cylindrical sidewall 7. Each output port 11 is adapted for connection to a secondary conduit 13. In the illustrated apparatus 1, a hose adapter 15 is attached over each output port 11 and is configured such that an inner surface 17 of the secondary conduit 13 is aligned with the opening of the output port 11 such that the air stream and entrained agricultural products will flow smoothly out the port 11 and into the secondary conduit 13.

An input port 19 is defined in the bottom wall 5, and a substantially vertically oriented input conduit 21 extends upward through the input port 19 into an upper portion of the manifold interior 9.

A plurality of substantially vertical channels 31 each extends downward from the inner top wall surface 29 to one of the output ports 11, and has an entrance opening 47 at a top end thereof adjacent to the inner top wall surface 29. The channels 31 are defined by divider plates 39 that extend down from the inner top wall surface 29 between the sidewall 7 and the input conduit 21. To facilitate a smooth flow of air and product and reduce resistance to flow a smoothly curved transition surface 33 at a bottom end of the channel 31 connects the vertical channel 31 to the output port 11.

The upper portion of the manifold interior 9 is configured such that an air stream AS carrying entrained agricultural products passing out the open top end 27 of the input conduit 21 contacts the top wall 3 and is directed outward into the entrance openings 47, and such that a substantially equal portion of the air stream and entrained agricultural products flows into each entrance opening 47.

In a conventional manifold with a generally flat top wall, generally of a soft material to reduce seed damage, the air stream with entrained agricultural products blows up against the bottom surface and then laterally out the outlet ports. It is contemplated that such a flat top wall could be used to similarly direct the air stream and products into the entrance apertures 47 of the vertical channels 31 with satisfactory results however to improve flow and equality of division, in the illustrated apparatus 1, a divider cone 23 extends, with pointed end 25 down, from the top wall 3 above the open top end 27 of the input conduit 21 such that the axis AA of the cone is aligned with the longitudinal axis BB of the input conduit 21. Thus the center of air stream AS passing upward out the open top end 27 of the input conduit 21 contacts the pointed end 25 of the cone 23 and the air stream AS and the agricultural products entrained therein flows up the walls of the cone 23, and is substantially equally distributed along the surface of the cone 23. Again to facilitate smooth flow in the illustrated apparatus 1 the upper edge of the cone 23 transitions smoothly into the inner top wall surface 29 that curves outward and then downward into the sidewall.

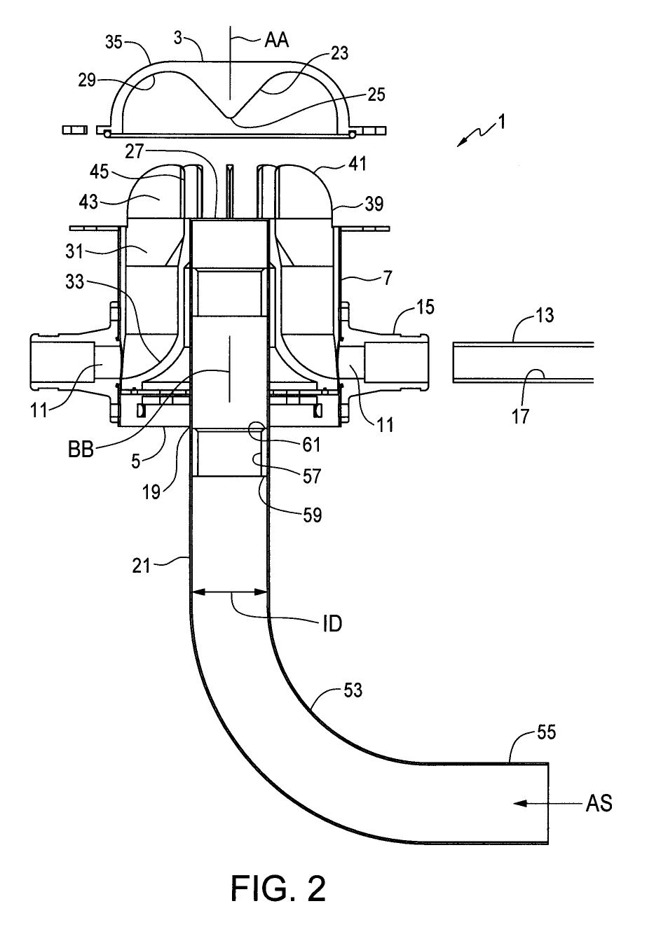

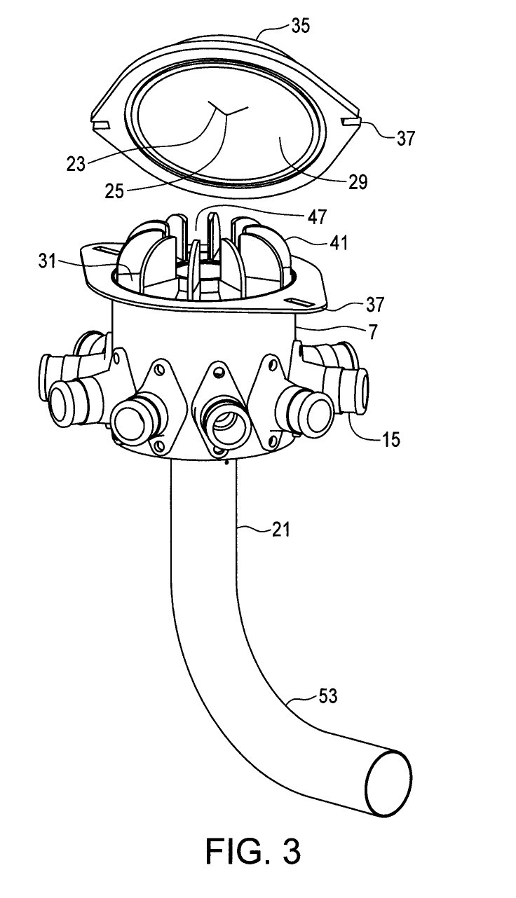

In the apparatus 1, the sidewall 7 is substantially cylindrical, and the top wall 3 and divider cone 23 are conveniently incorporated into a cap 35 that is releasably attached and sealed to the sidewall 7 by bolts through corresponding holes in the tabs 37 on the cap 35 and sidewall 7. The cap 35 is shown removed in FIGS. 2 and 3.

The channels 31 are defined by divider plates 39 that extend above the sidewall 7 into the cap 35 and have rounded top edges 41 that substantially correspond to the inner top wall surface 29, such that when the cap 35 is installed, as illustrated in FIG. 1, the rounded top edges 41 are in close proximity to the inner top wall surface 29. For convenience of production, the same cap 35 can thus be used regardless of the number of output ports 11 and corresponding channels 31.

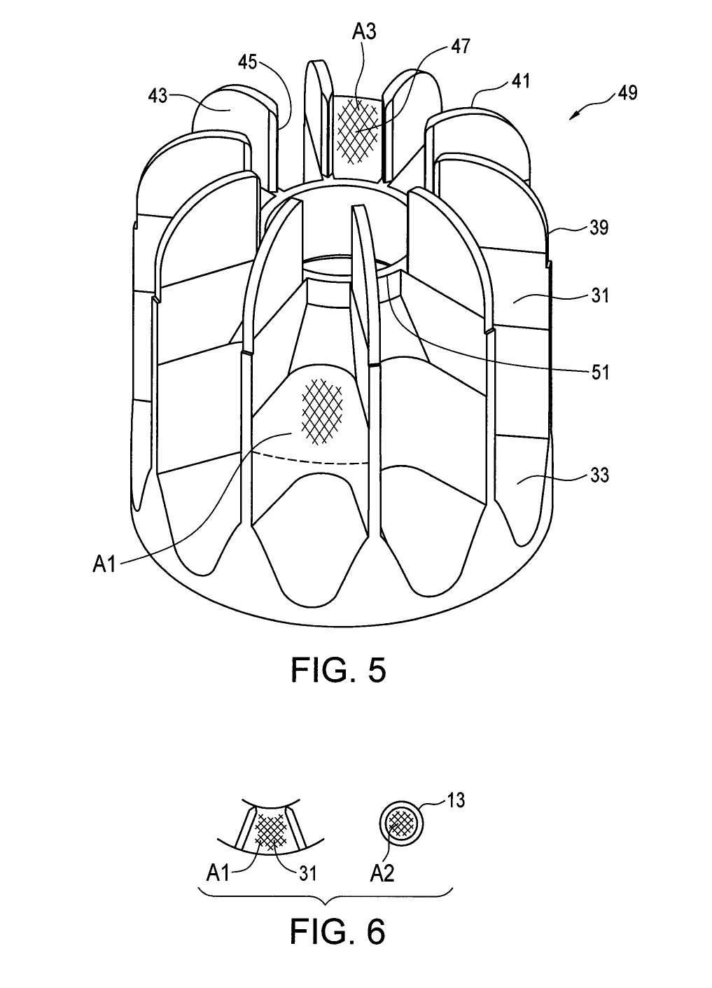

Upper portions 43 of the divider plates 39 extend substantially vertically above the open top end 27 of the input conduit 21. Inner edges 45 of the upper portions 43 of the divider plates 39 are beveled or sharpened and define a channel entrance opening 47, as best seen in FIG. 5, when the cap 35 is installed and the rounded top edges 41 are in close proximity to the inner top wall surface 29 of the cap 35. Thus the channel entrance opening 47 into each channel 31 is substantially vertical extending downward from about the upper edge of the cone 23 where the walls of the cone 23 transition into the inner top wall surface 29. Each channel entrance opening 47 is formed on each side by a beveled inner edge 45 such that agricultural products in the air stream AS flow smoothly into one entrance opening 47 or the adjacent entrance opening with reduced impact on the upper portions 43 of the divider plates 39 forming the opening 47.

Thus the center of air stream AS passing upward out the open top end 27 of the input conduit 21 contacts the pointed end 25 of the cone 23 and the air stream AS and the agricultural products entrained therein flows up the walls of the cone, and substantially equally through each entrance opening 47.

Conveniently the divider plates 39 are incorporated into an annular channel insert member 49 that is inserted in the manifold interior 9 between the sidewall 7 and the input conduit 21. The channel insert member 49 includes a cylindrical inner wall 51 that slides down and fits tightly around the top end of the input conduit 21.

The bottom end of the input conduit 21 is connected through an elbow 53 to a horizontal conduit 55 carrying the air stream AS from the air seeder product tanks. A number of pulsating rings 57 are located inside the input conduit 21 between the elbow 53 and the open top end 27 thereof. Although the number may vary, the illustrated apparatus 1 shows two of these pulsating rings 57 installed in the input conduit 21. The bottom edge 59 of each pulsating ring 57 extends inward substantially perpendicularly from the inner surface of the input conduit 21. The bottom edge 59 forms a blunt obstacle to the air stream AS and to agricultural products moving with the air stream AS along the inner surface of the input conduit 21, and disrupts the flow of product particles and air.

The upper edge 61 of the illustrated pulsating rings slopes from an inner surface thereof toward the inner surface of the input conduit 21. The upper edge may also be perpendicular to the inner surface of the input conduit 21 the same as the bottom edge 59.

The pulsating rings 57 are generally made of a somewhat soft resilient material, such as plastic, rubber or the like to reduce damage to seeds contacting the blunt bottom edges at high speed. Product particles contacting the bottom edges 59 of the rings 57 bounce around and impact other particles in the air stream, and generally create a chaotic flow with particles spinning and moving in random directions within the air stream flow.

The vertical input conduit 21 and pulsating rings 57 move the suspended particles of agricultural product into a random distribution through-out the cross section of the input conduit 21. In the horizontal conduit 55 the agricultural products tend to move toward the bottom side of the conduit in response to gravity, and the vertical input conduit 21 is designed to take out the effects of gravity. When the air flow switches from horizontal to vertical at the bottom of the input conduit 21, the product moving around the curved elbow 53 tends to the outside of the curve. Once the product reaches the vertical input conduit 21 it tends to rhythmically bounce from one side of the conduit to the other in an “S” pattern as it moves up. This rhythmic pattern changes with air speed, product speed, product density, product shape, product surface texture, and product quantity.

To achieve a more random product distribution within the conduit cross-section (without introducing extremely tall towers), a common practice is to use shorter towers and to introduce dimpling within the vertical input conduit 21. The dimples are formed by denting in a localized point of the wall of the input conduit 21. The dimples create a product flow chaos situation in the vertical input conduit 21 as the particles bounce off the dimples and helps reduce the rhythmic pattern of product flow. To overcome the rhythmic patterns manufacturers have introduced an increased number of dimples and have made the dimples more aggressive, which results in increased resistance to high product flows and plugging. The pulsating rings 57 of the present invention provide reduced resistance to air flow compared to an excessive number of dimples.

Prior art input conduits such as the tapering centering rings of Bourgault described above, try to direct entrained agricultural products toward the center of the air stream AS.

In the illustrated apparatus 1 of the present invention the inner diameter ID of the input conduit is substantially the same from the elbow 53 to the open top end 27 of the input conduit 21, except where the pulsating rings 57 reduce the effective inner diameter for a short distance. Entrained particles of agricultural products that impact the pulsating rings 57 cause the entrained particles of agricultural products to move in a more random manner with a view to distributing the entrained products equally across the cross-section of the input conduit 21, so that when the air stream AS contacts the pointed end 25 of the cone 23 and the air stream AS is substantially equally distributed into each channel entrance opening 47, each channel 31 receives a substantially equal proportion of the entrained agricultural products as well as an equal proportion of the air stream AS.

By centering the particles of agricultural products in the air stream AS as in the prior art of at least Bourgault, a small deviation of the center of the stream of agricultural product particles from the center of the top plate shown in Bourgault will result in an increased variation in product distribution compared to where the product is evenly distributed across the entire cross-section of the input conduit as in the present invention.

The impact of the product particles on the bottom edge 59 of the pulsating rings 57 causes the particles to spin and bounce against each other such that the particles have kinetic energy not only from their forward motion in the direction of the air stream AS along the input conduit 21, but also random kinetic energy from spinning and moving laterally randomly across the input conduit 21.

As seen in FIGS. 5 and 6, the cross-sectional area A1 of at least a middle portion of each channel 31 is greater than the cross-sectional area A2 of the secondary conduits 13. The cross-sectional area A1 is also greater than the cross-sectional area A3 of the entrance opening 47. Thus as the air stream passes through the entrance openings 47 into the channels 31, the speed of the air stream drops somewhat as the volume of the passage the air stream is passing through expands and the particles begin to move downward in the channels 31. The particles are also accelerated by gravity in the channel 31 and this combination of reduced speed and gravity at least somewhat reorients the particles and reduces the random kinetic energy thereof such that the particles are more readily carried in a smooth flow in the air stream along the smoothly curved transition surface 33 at the bottom end of the channels 31, and into the secondary conduits 13, and the incidence of plugging is reduced.

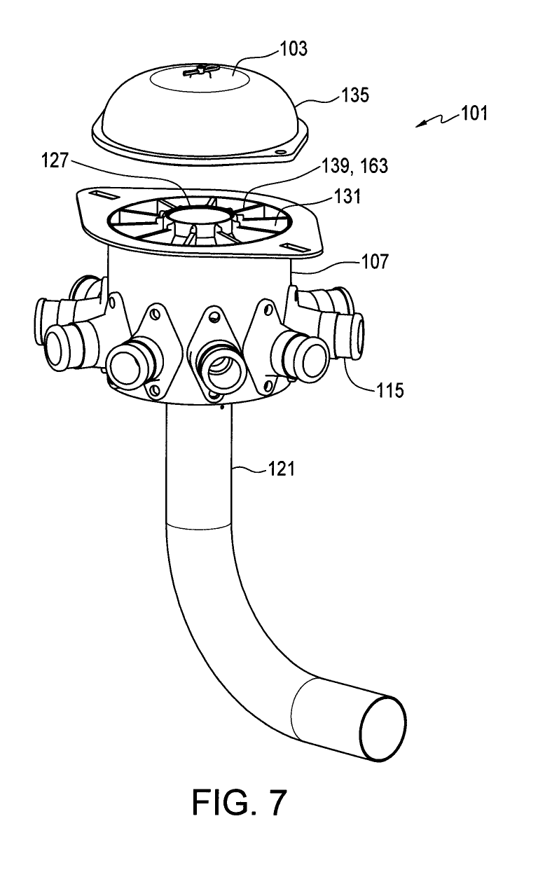

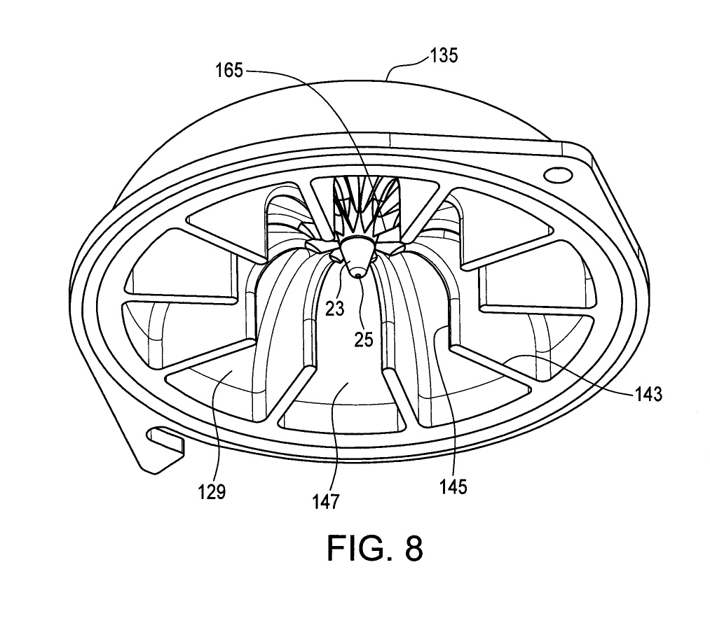

FIGS. 7 and 8 illustrate another embodiment of a manifold apparatus 101 of the present invention for use on an air seeder where the channels 131 are defined by divider plates 139 extending between the sidewall 107 and the input conduit 121, and wherein upper portions 143 of the divider plates 139 extend above the open top end 127 of the input conduit 121 and curve to join the inner top wall surface 129 and an upper portion of a wall of the cone 123 such that inner edges 145 of the upper portions 143 of the divider plates 139 define curved entrance openings 147.

In the apparatus 101, the agricultural product particles will flow up the sloped wall of the cone 123. Upper ends 165 of the inner edges 145 of the upper portions 143 of the divider plates 139 adjacent to the cone 123 are therefore beveled to reduce impact damage.

As in the apparatus 1 described above, in apparatus 101 the sidewall is substantially cylindrical, and the top wall 103, divider cone 123, and curved upper portions 143 of the divider plates 139 are incorporated into a cap 135 that is releasably attachable to the sidewall 107. When the cap 135 is attached to the sidewall 107, the upper portions 143 of the divider plates 139 are aligned with lower portions 163 of the divider plates 139 that are located between the sidewall 107 and the input conduit 121. In the apparatus 101 the cap 135 must be selected to correspond to the number of channels 131 and output ports with hose adapters 115.

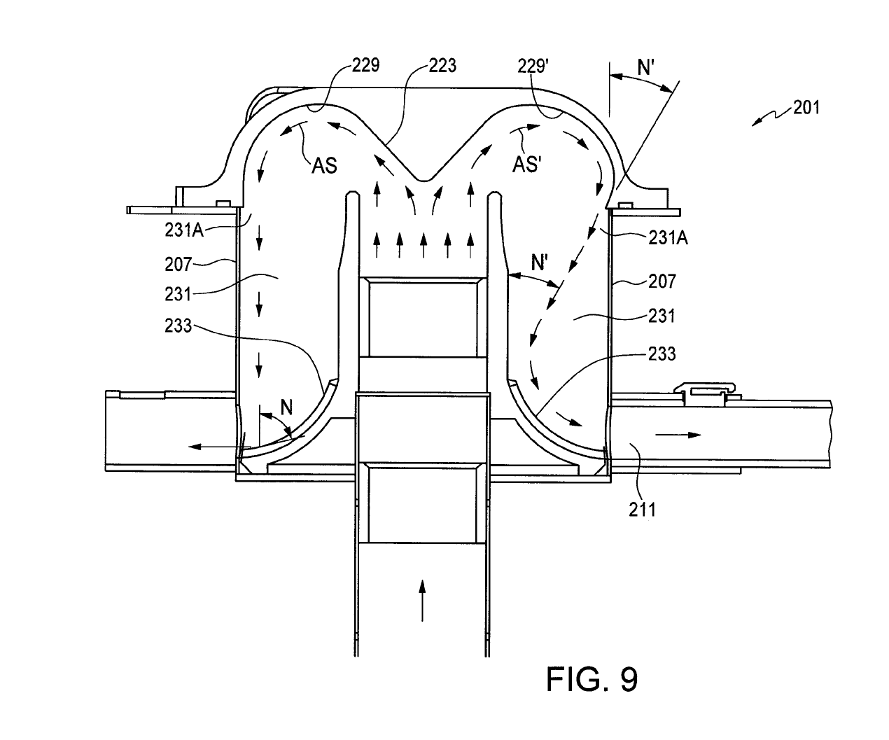

FIG. 9 schematically illustrates a further embodiment of a manifold apparatus 201 of the present invention for use on an air seeder. Again a smoothly curved transition surface 233 at a bottom end of an inner side of each vertical channel 231 connects the vertical channel to the output port 211. An upper edge of the cone 223 transitions smoothly into the inner top wall surface 229 as in the embodiments described above, however in the apparatus 201 the inner top wall surface 229′ on the right side of the drawing curves outward farther and then curves downward and back inward to the top edge of the sidewall 207, and in the illustrated embodiment somewhat past the inner surface of the sidewall 207, such that the surface 229′ is oriented at an angle N′ with respect to the sidewall 207, instead of being aligned vertical with the sidewall as in the embodiments above, and as illustrated in the inner top wall surface 229 on the left side of the drawing.

Thus in the apparatus 201 the agricultural products, indicated by the arrows, entrained in the air stream AS and moving along the right inner top wall surface 229′ are directed from an upper outer portion 231A of the vertical channel 231 downward and across the channel to an upper portion of the curved transition surface 233. The agricultural products contact the transition surface 233 at a relatively low angle N′ and follow the curved transition surface 233 to be redirected more smoothly to a horizontal flow direction out through the output port 211.

In contrast the agricultural products entrained in the air stream AS and moving along the left inner top wall surface 229 are directed from an upper outer portion 231A of the vertical channel 231 downward along the sidewall 207 and into contact with the bottom portion of the curved transition surface 233 where the surface 233 is almost horizontal and the impact angle N is much higher, and the speed of the air stream AS and products is more slowed and disrupted compared to the air stream AS′.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A manifold apparatus for an air seeder, the apparatus comprising:
a top wall, a bottom wall, and a side wall enclosing a manifold interior;
a plurality of output ports defined in a lower portion of the side wall, and spaced around the sidewall, each output port adapted for connection to a secondary conduit;
an input port defined in the bottom wall, and a substantially vertically oriented input conduit extending upward through the input port into an upper portion of the manifold interior;
a plurality of substantially vertical channels, each channel extending downward from an inner top wall surface to one of the outlet ports and having an entrance opening at a top end thereof;
wherein the upper portion of the manifold interior is configured such that an air stream carrying entrained agricultural products passing out an open top end of the input conduit contacts the top wall and is directed outward into the entrance openings, and such that a substantially equal portion of the air stream and agricultural products flows into each entrance opening.

2. The apparatus of claim 1 comprising a smoothly curved transition surface at a bottom end of each channel connecting the vertical channel to the output port.

3. The apparatus of claim 1 comprising a divider cone extending pointed end down from the top wall above the open top end of the input conduit and oriented such that an axis of the cone is aligned with a longitudinal axis of the input conduit.

4. The apparatus of claim 3 wherein an upper edge of the cone transitions smoothly into the inner top wall surface, and the inner top wall surface curves outward and then downward into the sidewall.

5. The apparatus of claim 4 wherein the channels are defined by divider plates extending down from the inner top wall surface between the sidewall and the input conduit.

6. The apparatus of claim 5 wherein inner edges of upper portions of the divider plates extend substantially vertically above the open top end of the input conduit to the inner top wall surface, such that the inner edges of the upper portions of the divider plates define substantially vertically oriented entrance openings.

7. The apparatus of claim 6 wherein the sidewall is substantially cylindrical, and the top wall and divider cone are incorporated into a cap that is releasably attachable to the sidewall.

8. The apparatus of claim 7 wherein the upper portions of the divider plates extend into the cap and have rounded top edges that substantially correspond to the inner top wall surface.

9. The apparatus of claim 6 wherein the inner edges of the upper portions of the divider plates are beveled.

10. The apparatus of claim 6 wherein the divider plates are incorporated into an annular channel insert member that is inserted in the manifold interior between the sidewall and the input conduit.

11. The apparatus of claim 5 wherein the channels are defined by divider plates extending between the sidewall and the input conduit, and wherein upper portions of the divider plates extend above the open top end of the input conduit and curve to join the inner top wall surface and an upper portion of a wall of the cone such that inner edges of the upper portions of the divider plates define curved entrance openings.

12. The apparatus of claim 11 wherein the sidewall is substantially cylindrical, and the top wall, divider cone, and curved upper portions of the divider plates are incorporated into a cap that is releasably attachable to the sidewall.

13. The apparatus of claim 12 wherein when the cap is attached to the sidewall, the upper portions of the divider plates are aligned with lower portions of the divider plates that are located between the sidewall and the input conduit.

14. The apparatus of claim 4 comprising a smoothly curved transition surface at a bottom end of an inner side of each vertical channel connecting the vertical channel to the output port and wherein an upper edge of the cone transitions smoothly into the inner top wall surface, and the inner top wall surface curves outward and then downward and inward to a top edge of the sidewall such that the agricultural products are directed from an upper outer portion of each vertical channel downward and across each channel to an upper portion of the curved transition surface.

15. The apparatus of claim 1 wherein a cross-sectional area of at least a middle portion of each channel is greater than a cross-sectional area of the secondary conduit.

16. The apparatus of claim 1 wherein a bottom end of the input conduit is connected through an elbow to a horizontal conduit, and wherein at least one pulsating ring is located inside the input conduit between the elbow and the open top end thereof, a bottom edge of the at least one pulsating ring extending inward substantially perpendicularly from an inner surface of the input conduit.

17. The apparatus of claim 16 wherein the at least one pulsating ring is made of a resilient material.

18. The apparatus of claim 16 wherein an upper edge of the at least one pulsating ring slopes from an inner surface thereof back toward the inner surface of the input conduit.

19. The apparatus of claim 16 wherein the inner diameter of the input conduit is substantially the same from the elbow to the open top end of the input conduit.

20. A substantially vertical input conduit for an air seeder manifold, wherein a bottom end of the input conduit is connected through an elbow to a horizontal conduit, and wherein a top end of the input conduit is connected to an input port of the manifold, the input conduit comprising at least one pulsating ring located inside the input conduit between the elbow and the top end thereof, and wherein a bottom edge of the at least one pulsating ring extends inward substantially perpendicularly from an inner surface of the input conduit.

21. The apparatus of claim 20 wherein the at least one pulsating ring is made of a resilient material.

22. The apparatus of claim 20 wherein an upper edge of the at least one pulsating ring slopes from an inner surface thereof toward the wall.

23. The apparatus of claim 20 wherein the inner diameter of the input conduit is substantially the same from the elbow to the open top end of the input conduit.
